(19) United States
(12) Patent Application Publication
(10) Pub. No.: US 2008/0105662 A1
(43) Pub. Date: May 8, 2008

(54) Laser beam processing method and laser beam processing machine

(76) Inventors: Koichi Shigematsu, Tokyo (JP); Yusuke Nagai, Tokyo (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/004,405

(22) Filed: Dec. 21, 2007

Related U.S. Application Data
(63) Continuation of application No. 10/880,452, filed on Jul. 1, 2004, now abandoned.

(30) Foreign Application Priority Data
Jul. 9, 2003 (JP) 2003-272483

(51) Int. Cl. B23K 26/38

(52) U.S. Cl. 219/121.67

(57) ABSTRACT

A laser beam processing method comprising holding a plate-like workpiece having dividing lines formed in a lattice pattern on the front surface on a chuck table and applying a laser beam capable of passing through the plate-like workpiece to the plate-like workpiece held on the chuck table along the dividing lines to form a deteriorated layer in the inside of the plate-like workpiece along the dividing lines, wherein a height position detection step of detecting the position of a height of the surface on the side to which the laser beam is applied, of the plate-like workpiece held on the chuck table along a dividing line; and a laser beam application step of applying a laser beam to the workpiece along the dividing line while controlling the position of the focusing point of the laser beam corresponding to the position of the height detected in the height position detection step.

### FIELD OF THE INVENTION

The present invention relates to a laser beam processing method comprising holding a plate-like workpiece having dividing lines formed on the front surface in a lattice pattern on a chuck table and applying a laser beam capable of passing through the plate-like workpiece to the plate-like workpiece held on the chuck table along the dividing lines to form a deteriorated layer in the inside of the plate-like workpiece along the dividing lines, and to a laser beam processing machine.

### DESCRIPTION OF THE PRIOR ART

In the production process of a semiconductor device, a plurality of areas are sectioned by streets (dividing lines) formed in a lattice pattern on the front surface of a substantially disk-like semiconductor wafer and a circuit such as IC or LSI is formed in each of the sectioned areas. The semiconductor wafer is cut along the dividing lines to be divided into the circuit-formed areas, thereby manufacturing individual semiconductor chips. An optical device wafer having a gallium nitride-based compound semiconductor layer or the like laminated on the front surface of a sapphire substrate is also cut along dividing lines to be divided into individual optical devices such as light-emitting diodes, laser diodes or the like, which are widely used in electric equipment.

Cutting the above semiconductor wafer or optical device wafer along the dividing lines is generally carried out by a cutting machine called “dicer”. This cutting machine has a chuck table for holding a workpiece such as a semiconductor wafer or optical device wafer, a cutting means for cutting the workpiece held on the chuck table, and a moving means for moving the chuck table and the cutting means relative to each other. The cutting means comprises a rotary spindle that is rotated at a high speed and a cutting blade mounted to the spindle. The cutting blade comprises a disk-like base and an annular edge that is mounted to the side wall outer periphery of the base and formed as thick as about 20 μm by fixing diamond abrasive grains having a diameter of about 3 μm to the base by electroforming.

Further, since a sapphire substrate, silicon carbide substrate or lithium tantalate substrate has a high Mohs hardness, cutting with the above cutting blade is not always easy. Since the cutting blade has a thickness of about 20 μm, the dividing lines for sectioning each device must have a width of about 50 μm. Therefore, in the case of a device measuring about 300 μm×300 μm for example, the area ratio of the dividing lines is large, thereby reducing productivity.

Meanwhile, as means of dividing a plate-like workpiece such as a semiconductor wafer, a laser beam processing method in which a laser beam capable of passing through the plate-like workpiece is used and the laser beam is applied to the plate-like workpiece with its converging point on the inside of the area to be divided is now undertaken. This dividing method making use of a laser beam is to divide a plate-like workpiece by applying a laser beam having an infrared range, which can pass through the plate-like workpiece, with its converging point on the inside from one side of the plate-like workpiece so as to continuously form a deteriorated layer in the inside of the plate-like workpiece along dividing lines and applying external force along the dividing lines whose strength has been reduced due to the formation of the deteriorated layer, as disclosed by JP-A 2002-192367, for example.

There is also proposed a laser beam processing method in which a deteriorated layer is slightly exposed to the surface on the side opposite to the side, to which the laser beam is applied, of a plate-like workpiece in order to divide the plate-like workpiece smoothly when the plate-like workpiece having the deteriorated layer formed therein along dividing lines is to be divided along the dividing lines by applying external force as described above.

When the plate-like workpiece is not uniform in thickness, however, there is a problem that the deteriorated layer cannot be uniformly exposed to the surface on the side opposite to the side, to which the laser beam is applied, of the plate-like workpiece. That is, when the plate-like workpiece (W) has a predetermined thickness (t) as shown in FIG. 8(a), the deteriorated layer (A) can be uniformly exposed to the side, to which the laser beam (LB) is applied, of the plate-like workpiece (W) by applying a laser beam (LB) to it with its focusing point (P) on a predetermined inside position. In the case where the plate-like workpiece (W) has a thickness (t1) that is smaller than the predetermined thickness (t) as shown in FIG. 8(b), however, the distance from the surface on the side opposite to the side to which the laser beam (LB) is applied, to the focusing point (P1) becomes large due to the relationship with the refractive index of the laser beam (LB) when the laser beam (LB) is applied from the same height as in the case shown in FIG. 8(a). As a result, the deteriorated layer (A) formed by the laser beam (LB) is not exposed to the surface on the side opposite to the side to which the laser beam is applied. Meanwhile, in the case where the thickness (t2) of the plate-like workpiece (W) is larger than the predetermined thickness (t) as shown in FIG. 8(c), the distance from the surface on the side opposite to the side to which the laser beam (LB) is applied, to the focusing point (P2) becomes small due to the relationship with the refractive index of the laser beam (LB) when a laser beam (LB) is applied from the same height as in the case shown in FIG. 8(a). As a result, the deteriorated layer (A) formed by the laser beam (LB) is exposed great to the surface on the side opposite to the side to which the laser beam is applied. Therefore, when the deteriorated layer is formed in the inside of a plate-like workpiece (W) by applying a laser beam to the plate-like workpiece (W) which is formed in such a shape that the center portion is thick and the thickness gradually becomes thinner toward its outer periphery, based on the center portion as the standard height as shown in FIG. 8(d), the deteriorated layer (A) at a position away from the center does not reach the surface (undersurface in the figure) on the side opposite to the side to which the laser beam is applied, the distance between the surface (lower surface in the figure) on the side opposite to the side to which the laser beam is applied and the deteriorated layer (A) becomes larger toward the outer periphery, and hence, the deteriorated layer (A) cannot be formed at a desired position.

### SUMMARY OF THE INVENTION

It is an object of the present invention to provide a laser beam processing method and a laser beam processing machine, which are capable of forming a deteriorated layer at a desired position of a plate-like workpiece even when the plate-like workpiece is not uniform in thickness.

To attain the above object, according to the present invention, there is provided a laser beam processing method comprising holding a plate-like workpiece having dividing lines formed in a lattice pattern on the front surface on a chuck table and applying a laser beam capable of passing through the plate-like workpiece to the plate-like workpiece held on the chuck table along the dividing lines to form a deteriorated layer in the inside of the plate-like workpiece along the dividing lines, wherein:

a height position detection step of detecting the position of a height of the surface on the side to which the laser beam is applied, of the plate-like workpiece held on the chuck table along a dividing line; and

a laser beam application step of applying a laser beam to the workpiece along the dividing line while controlling the position of the focusing point of the laser beam corresponding to the position of the height detected in the height position detection step.

According to the present invention, there is also provided a laser beam processing machine for applying a laser beam capable of passing through a plate-like workpiece to the plate-like workpiece having dividing lines formed in a lattice pattern on the front surface along the dividing lines to form a deteriorated layer in the inside of the plate-like workpiece along the dividing lines, comprising:

a chuck table for holding the plate-like workpiece;

a laser beam application means for applying a laser beam to the plate-like workpiece held on the chuck table;

a processing-feed means for moving the chuck table and the laser beam application means relative to each other in the horizontal plane;

a focusing point position control means for controlling the position of the focusing point of the laser beam applied by the laser beam application means;

a height position detection means for detecting the position of a height of the surface on the side to which the laser beam is applied, of the plate-like workpiece held on the chuck table along the dividing lines;

a storage means for storing the position of the height information detected by the height position detection means; and

a control means for controlling the focusing point position control means based on the information stored in the storage means.

The above control means obtains a correction value based on the difference between the position of the height at the standard position and the position of the height at the current position of the surface and the refraction coefficient of the plate-like workpiece, and controls the focusing point position control means based the correction value.

The above height position detection means detects the positions of heights of predetermined several points of the plate-like workpiece, and the control means obtains an undulation function f(x) of a dividing line from the position of each height detected by the height position detection means, and obtains a correction value based on the undulation function f(x) and the refraction coefficient of the plate-like workpiece to control the focusing point position control means based on the correction value.

In the present invention, since the position of a height of the surface on the side to which the laser beam is applied, of the plate-like workpiece held on the chuck table along a dividing line is detected and a laser beam is applied along the dividing line while the position of the focusing point of the laser beam is controlled according to the position of the above height, a deteriorated layer can be formed at a desired position of the plate-like workpiece, even when the plate-like workpiece is not uniform in thickness.

### BRIEF DESCRIPTION OF THE DRAWINGS

FIG. 1 is a perspective view of a laser beam processing machine constituted according to the present invention;

FIG. 2 is a block diagram schematically showing the constitution of the laser beam application means in the laser beam processing machine shown in FIG. 1;

FIG. 3 is a perspective view of a semiconductor wafer as a workpiece to be processed by the laser beam processing method of the present invention;

FIGS. 4(a) and 4(b) are diagrams for explaining the height position detection step in the laser beam processing method of the present invention;

FIGS. 5(a) and 5(b) are diagrams for explaining the laser beam application step in the laser beam processing method of the present invention;

FIG. 6 is a diagram for explaining the laser beam application step in the laser beam processing method of the present invention;

FIGS. 7(a) and 7(b) are diagrams of another embodiment for controlling the position of the focusing point of a laser beam in the laser beam processing method of the present invention; and

FIGS. 8(a) to 8(d) are diagrams for explaining deteriorated layers formed by the laser beam processing method of the prior art.

### DETAILED DESCRIPTION OF THE PREFERRED EMBODIMENTS

The laser beam processing method and laser beam processing machine according to the present invention will be described in detail hereinunder with reference to the accompanying drawings.

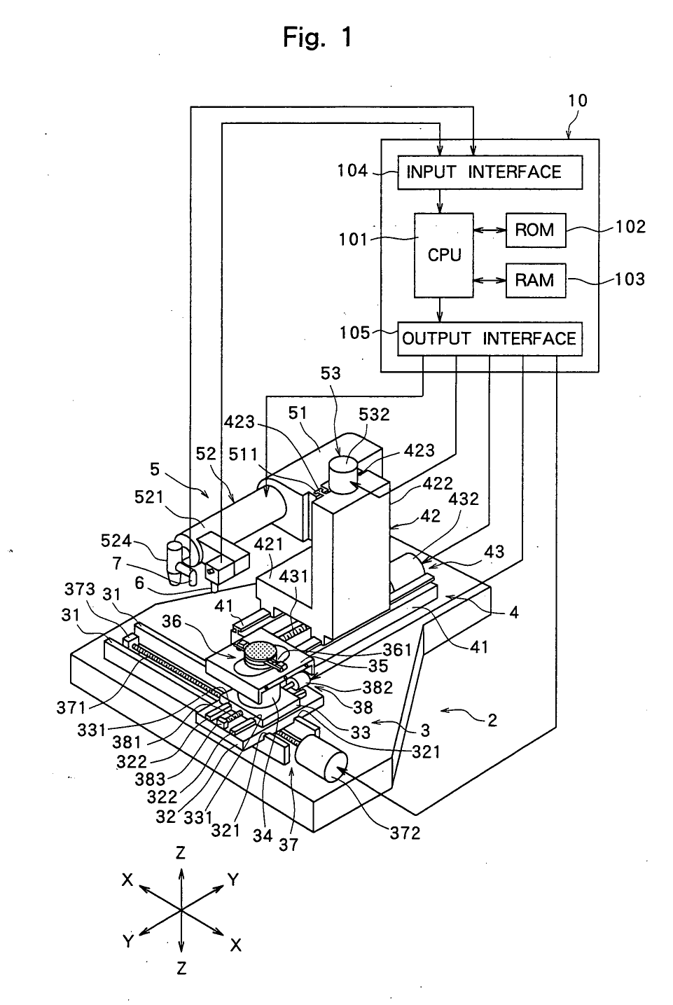

FIG. 1 is a perspective view of a laser beam processing machine constituted according to the present invention. The laser beam processing machine 1 shown in FIG. 1 comprises a stationary base 2, a chuck table mechanism 3 that is disposed on the stationary base 2 in such a manner that it can move in a processing-feed direction indicated by an arrow X and holds a workpiece, a laser beam application unit support mechanism 4 disposed on the stationary base 2 in such a manner that it can move in an indexing-feed direction indicated by an arrow Y perpendicular to the direction indicated by the arrow X, and a laser beam application unit 5 disposed on the laser beam application unit support mechanism 4 in such a manner that it can move in a focusing point position control direction indicated by an arrow Z.

The above chuck table mechanism 3 comprises a pair of guide rails 31 and 31 disposed on the stationary base 2 and arranged parallel to each other along the direction indicated by the arrow X, a first sliding block 32 disposed on the guide rails 31 and 31 in such a manner that it can move in the direction indicated by the arrow X, a second sliding block 33 disposed on the first sliding block 32 in such a manner that it can move in the direction indicated by the arrow Y, a support table 35 supported on the second sliding block 33 by a cylindrical member 34, and a chuck table 36 as workpiece holding means. This chuck table 36 has an adsorption chuck 361 made of a porous material and is so constituted as to hold a disk-like semiconductor wafer as a workpiece on the adsorption chuck 361 by a suction means that is not shown. The chuck table 36 is rotated by a pulse motor (not shown) installed in the cylindrical member 34.

The above first sliding block 32 has, on its undersurface, a pair of to-be-guided grooves 321 and 321 to be fitted to the above pair of guide rails 31 and 31 and has, on its top surface, a pair of guide rails 322 and 322 formed parallel to each other along the direction indicated by the arrow Y. The first sliding block 32 constituted as described above is constituted to be movable in the direction indicated by the arrow X along the pair of guide rails 31 and 31 by fitting the to-be-guided grooves 321 and 321 onto the pair of guide rails 31 and 31, respectively. The chuck table mechanism 3 in the illustrated embodiment has a processing-feed means 37 for moving the first sliding block 32 along the pair of guide rails 31 and 31 in the direction indicated by the arrow X. The processing-feed means 37 comprises a male screw rod 371 arranged between the above pair of guide rails 31 and 31 and in parallel thereto, and a drive source such as a pulse motor 372 for rotary-driving the male screw rod 371. The male screw rod 371 is, at its one end, rotatably supported onto a bearing block 373 fixed on the above stationary base 2 and is, at the other end, transmission-coupled to the output shaft of the above pulse motor 372 by a speed reducer that is not shown. The male screw rod 371 is screwed into a threaded through-hole formed in a female screw block (not shown) projecting from the undersurface of the center portion of the first sliding block 32. Therefore, by driving the male screw rod 371 in a normal direction or reverse direction by the pulse motor 372, the first sliding block 32 is moved along the guide rails 31 and 31 in the processing-feed direction indicated by the arrow X.

The above second sliding block 33 has, on its undersurface, a pair of to-be-guided grooves 331 and 331 to be fitted to the pair of guide rails 322 and 322 on the top surface of the above first sliding block 32, and is constituted to be movable in the direction indicated by the arrow Y by fitting the to-be-guided grooves 331 and 331 to the pair of guide rails 322 and 322, respectively. The chuck table mechanism 3 in the illustrated embodiment has a first indexing-feed means 38 for moving the second sliding block 33 in the direction indicated by the arrow Y along the pair of guide rails 322 and 322 on the first sliding block 32. The first indexing-feed means 38 comprises a male screw rod 381 arranged between the above pair of guide rails 322 and 322 and in parallel thereto, and a drive source such as a pulse motor 382 for rotary-driving the male screw rod 381. The male screw rod 381 is, at its one end, rotatably supported onto a bearing block 383 fixed on the top surface of the above first sliding block 32 and is, at the other end, transmission-coupled to the output shaft of the above pulse motor 382 by a speed reducer that is not shown. The male screw rod 381 is screwed into a threaded through-hole formed in a female screw block (not shown) projecting from the undersurface of the center portion of the second sliding block 33. Therefore, by driving the male screw rod 381 in a normal direction or reverse direction by the pulse motor 382, the second sliding block 33 is moved along the guide rails 322 and 322 in the indexing direction indicated by the arrow Y.

The above laser beam application unit support mechanism 4 has a pair of guide rails 41 and 41 arranged parallel to each other on the stationary base 2 along the indexing direction indicated by the arrow Y and a movable support base 42 disposed on the guide rails 41 and 41 in such a manner that it can move in the direction indicated by the arrow Y. This movable support base 42 comprises a movable support portion 421 movably disposed on the guide rails 41 and 41 and a mounting portion 422 attached to the movable support portion 421. The mounting portion 422 is provided, at its side face, with a pair of parallel guide rails 423 and 423 extending in the direction indicated by the arrow Z. The laser beam application unit support mechanism 4 in the illustrated embodiment comprises a second indexing-feed means 43 for moving the movable support base 42 along the pair of guide rails 41 and 41 in the indexing-feed direction indicated by the arrow Y. This second indexing-feed means 43 comprises a male screw rod 431 arranged between the above pair of guide rails 41 and 41 and in parallel thereto, and a drive source such as a pulse motor 432 for rotary-driving the male screw rod 431. The male screw rod 431 is, at its one end, rotatably supported onto a bearing block (not shown) fixed on the above stationary base 2 and is, at the other end, transmission-coupled to the output shaft of the above pulse motor 432 by a speed reducer that is not shown. The male screw rod 431 is screwed into a threaded through-hole formed in a female screw block (not shown) projecting from the undersurface of the center portion of the movable support portion 421 constituting the movable support base 42. Therefore, by driving the male screw rod 431 in a normal direction or reverse direction by the pulse motor 432, the movable support base 42 is moved along the guide rails 41 and 41 in the indexing-feed direction indicated by the arrow Y.

The laser beam application unit 5 in the illustrated embodiment comprises a unit holder 51 and a laser beam application means 52 secured to the unit holder 51. The unit holder 51 has a pair of to-be-guided grooves 511 and 511 to be slidably fitted onto the pair of guide rails 423 and 423 on the above mounting portion 422, and is supported in such a manner that it can move in the direction indicated by the arrow Z by fitting the to-be-guided grooves 511 and 511 to the above guide rails 423 and 423, respectively.

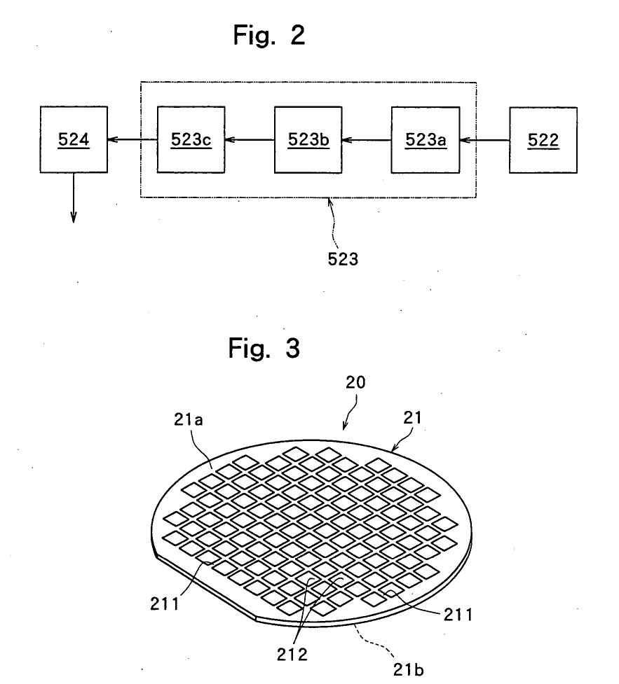

The illustrated laser beam application means 52 comprises a cylindrical casing 521 secured to the above unit holder 51 and extending substantially horizontally. In the casing 521, there are installed a laser beam oscillation means 522 and a laser beam modulation means 523 as shown in FIG. 2. A YAG laser oscillator or a YVO4 laser oscillator may be used as the laser beam oscillation means 522. The laser beam modulation means 523 comprises a repetition frequency setting means 523a, a laser beam pulse width setting means 523b and a laser beam wavelength setting means 523c. The repetition frequency setting means 523a, laser beam pulse width setting means 523b and laser beam wavelength setting means 523c constituting the laser beam modulation means 523 may be known devices to people of ordinary skill in the art and therefore, detailed descriptions of their structures are omitted in this text. A condenser 524 which may be of a type known per se is attached to the end of the above casing 521.

A laser beam oscillated from the above laser beam oscillation means 522 reaches the condenser 524 through the laser beam modulation means 523. In the laser beam modulation means 523, the repetition frequency setting means 523a converts the laser beam into a pulse laser beam having a predetermined repetition frequency, the laser beam pulse width setting means 523b sets the pulse width of the pulse laser beam to a predetermined width, and the laser beam wavelength setting means 523c sets the wavelength of the pulse laser beam to a predetermined value.

An alignment means 6 for detecting the processing area to be processed by the above laser beam application means 52 is mounted on the front end of the casing 521 constituting the above laser beam application means 52. This alignment means 6 in the illustrated embodiment comprises an infrared illumination means for illuminating infrared radiation to the workpiece, an optical system for capturing the infrared radiation illuminated by the infrared illumination means and an image pick-up device (infrared CCD) for outputting an electric signal corresponding to the infrared radiation captured by the optical system, in addition to an ordinary image pick-up device (CCD) for taking an image with visible radiation, and transmits an image signal to a control means which will be described later.

The laser beam processing machine in the embodiment comprises a height position detection means 7 for detecting the position of a height of the surface (top surface of the plate-like workpiece held on the chuck table 36) on the side to which the laser beam is applied, of the plate-like workpiece as the workpiece held on the above chuck table 36. This height position detection means 7 is mounted on the condenser 524 constituting the laser beam application means 52 in this embodiment, may be composed of an air gap sensor or ultrasonic sensor, and transmits a detection signal to the control means which will be described later.

The laser beam application unit 5 in the illustrated embodiment has a focusing point position control means 53 for moving the unit holder 51 along the pair of guide rails 423 and 423 in the direction indicated by the arrow Z. Like the above feed means, the focusing point position control means 53 comprises a male screw rod (not shown) arranged between the pair of guide rails 423 and 423, and a drive source such as a pulse motor 532 for rotary-driving the male screw rod. By driving the male screw rod (not shown) in a normal direction or reverse direction by the pulse motor 532, the unit holder 51 and the laser beam application means 52 are moved along the guide rails 423 and 423 in the focusing point position control direction indicated by the arrow Z. Therefore, the focusing point position control means 53 has the function of controlling the position of the focusing point of a laser beam applied by the laser beam application means 52.

The laser beam processing machine in the illustrated embodiment has a control means 10. The control means 10 is composed of a microcomputer, and comprises a central processing unit (CPU) 101 which processes operations according to a control program, a read-only memory (ROM) 102 for storing the control program, a random access memory (RAM) 103 which stores the results of operations and enables information to be read therefrom and written thereto, an input interface 104 and an output interface 105. The random access memory (RAM) 103 functions as a storage means for storing information on the position of a height of the surface on the side to which the laser beam is applied, of the plate-like workpiece detected by the above height position detection means 7. Detection signals from the alignment means 6 and the height position detection means 7 are input to the input interface 104 of the control means 10 thus constituted. Control signals are output to the above pulse motor 372, pulse motor 382, pulse motor 432, pulse motor 532 and laser beam application means 52 from the output interface 105.

A description is subsequently given of the laser beam processing method for processing a semiconductor wafer as the workpiece by using the above-described laser beam processing machine.

FIG. 3 is a perspective view of a semiconductor wafer to be processed by the laser beam processing method of the present invention. In the semiconductor wafer 20 shown in FIG. 3, a plurality of areas are sectioned by a plurality of streets (dividing lines) 211 formed in a lattice pattern on the front surface 21a of a semiconductor substrate 21 such as a silicon wafer, and a circuit 212 such as IC or LSI is formed in each of the sectioned areas.

A protective tape is affixed to the front surface 21a of the semiconductor wafer 20 constituted as described above, the semiconductor wafer 20 is carried to the top of the adsorption chuck 361 of the chuck table 36 constituting the chuck table mechanism 3 of the laser beam processing machine 1 shown in FIG. 1 in such a manner that its rear surface 20b faces up, and its protective tape side is suction-held on the adsorption chuck 361. The chuck table 36 suction-holding the semiconductor wafer 20 is moved along the guide rails 31 and 31 by the operation of the processing-feed means 37 to be positioned right below the alignment means 6 mounted to the laser beam application unit 5.

After the chuck table 36 is positioned right below the alignment means 6, an alignment work for detecting the processing area of the semiconductor wafer 20 is carried out by the alignment means 6 and the control means 10. That is, the alignment means 6 and the control means 10 carry out image processing such as pattern matching to align a dividing line 211 formed on the semiconductor wafer 20 in a predetermined direction with the condenser 524 of the laser beam application unit 5 for applying a laser beam along the dividing line 211, thereby performing the alignment of a laser beam application position. Similarly, the alignment of the laser beam application position is also carried out for dividing lines 211 extending in a direction perpendicular to the above predetermined direction and formed on the semiconductor wafer 20. Although the front surface 21a on which the dividing line 211 of the semiconductor wafer 20 is formed, faces down, the image of the dividing lines 211 can be taken from the rear surface 21b because the alignment means 6 comprises infrared illumination means, optical system for capturing infrared radiation and image pick-up means composed of an image pick-up device (infrared CCD) for outputting an electric signal corresponding to the infrared radiation, as described above.

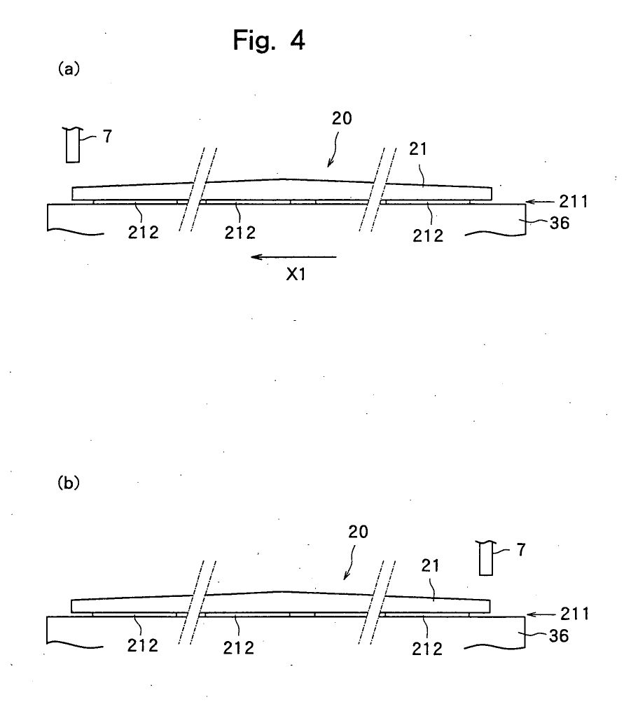

After the street 211 formed on the semiconductor wafer 20 held on the chuck table 36 is detected and the alignment of the laser beam application position is carried out as described above, the chuck table 36 is moved to bring one end (left end in the figure) of a predetermined dividing line 211 to a position right below the height position detection means 7 as shown in FIG. 4(a). Then, the position of a height of the surface (top surface of the plate-like workpiece held on the chuck table) on the side to which the laser beam is applied is detected by the height position detection means 7 in the course of movement of the chuck table 36 in a direction indicated by an arrow X1 until the height position detection means 7 reaches the other end (right end in the figure) of the predetermined dividing line 211 of the semiconductor wafer 20 as shown in FIG. 4(b), and its detection signal is sent to the control means 10. The control means 10 calculates the X and Z coordinate values of the surface on the side to which the laser beam is applied along the predetermined dividing line 211, from the height position detection signal sent from the height position detection means 7 and the moving position of the chuck table 36, and temporarily stores them in the random access memory (RAM) 103 (height position detection step).

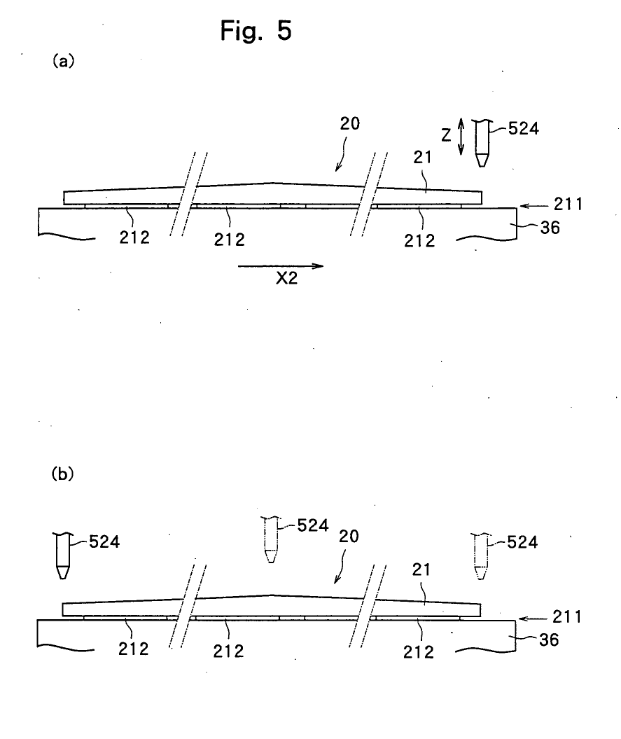

Thereafter, the chuck table 36 is moved to bring the other end (right end in the figure) of the predetermined dividing line 211, whose X and Z coordinate values have been detected, on the surface on the side to which the laser beam is applied, of the semiconductor wafer 20, to a position right below the condenser 524 of the laser beam application means 52 as shown in FIG. 5(a). The chuck table 36 is then moved in a direction indicated by an arrow X2 at a predetermined processing-feed rate until the condenser 524 reaches one end (left end in the figure) of the predetermined dividing line 211 of the semiconductor wafer 20 as shown in FIG. 5(b) while a laser beam is applied from the condenser 524 (laser beam application step). During this, the control means 10 controls the pulse motor 532 of the focusing point position control means 53 based on the X and Z coordinate values of the surface on the side to which the laser beam is applied, which have been stored in the random access memory (RAM) 103 in the above height position detection step, to adjust the position of the height, that is, the position in the Z-axis direction, of the condenser 524. In other words, the control means 10 first obtains a correction value for the X and Z coordinate values of the surface on the side to which the laser beam is applied, of the semiconductor wafer 20 from the following equation:
correction value=(standard value−current value)×refraction coefficient
wherein the standard value is the position of a height at the standard position (for example, the standard thickness of the wafer); the current value is the position of a height at the current position; and the refraction coefficient is the flexure coefficient of a workpiece in the air (for example, 0.25 in the case of silicon).

After the correction value is obtained, the control means 10 obtains the position in the Z-axis direction of the condenser 524 from the following equation:
position in Z-axis direction=position of set height+correction value
wherein the position of set height is a position in the Z-axis direction at the standard position.

The control means 10 controls the pulse motor 532 of the focusing point position control means 53 based on the thus obtained position in the Z-axis direction to position the condenser 524 at the position in the Z-axis direction.

As a result, the deteriorated layer 210 formed in the inside of the semiconductor wafer 20 is uniformly exposed to the surface on the side (undersurface of the plate-like workpiece held on the chuck table 36) opposite to the side to which the laser beam is applied. In the illustrated embodiment, the deteriorated layer can be thus formed at a desired position in the thickness direction of the semiconductor wafer 20.

The following processing conditions are set for the above laser beam application step.

Laser: YVO4 pulse laser

Wavelength: 1,064 nm

Pulse energy: 1.0 μJ

Repetition frequency: 100 kHz

Pulse width: 25 ns

Focusing spot diameter: 1 μm

Peak power density of focusing point: 5.1×10E10W/cm²

Processing-feed rate: 100 mm/sec.

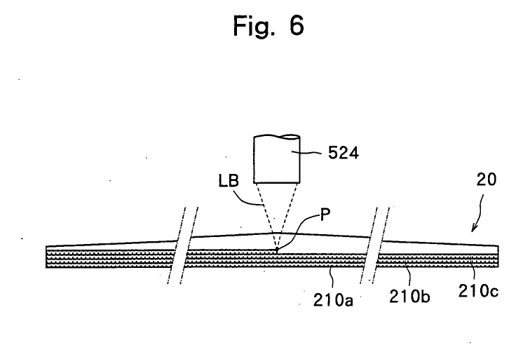

When the semiconductor wafer 20 is thick, a plurality of deteriorated layers 210a, 210b and 210c are desirably formed by changing the focusing point P stepwise to carry out the above laser beam application step several times, as shown in FIG. 6. The formation of the deteriorated layers 210a, 210b and 210c is preferably carried out by shifting the focusing point of a laser beam in the order of 210a, 210b and 210c stepwise.

In the above embodiment, the height position detection step and the laser beam application step are carried out for each dividing line. The height position detection step, however, may be carried out for all the dividing lines and information on all the dividing lines may be stored in the random access memory (RAM) 103 prior to the laser beam application step.

After the deteriorated layer is formed along all the streets 211 of the semiconductor wafer 20 as described above, the chuck table 36 holding the semiconductor wafer 20 is returned to the position where it first suction-held the semiconductor wafer 20 to cancel its suction-holding of the semiconductor wafer 20. The semiconductor wafer 20 is then carried to the dividing step by a conveying means that is not shown.

Another embodiment of the present invention in which the focusing point of a laser beam is controlled will be described below.

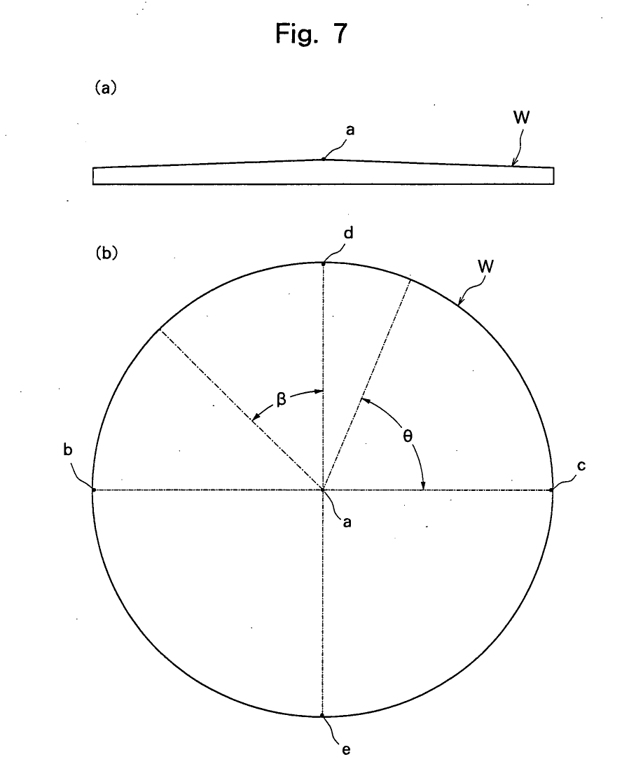

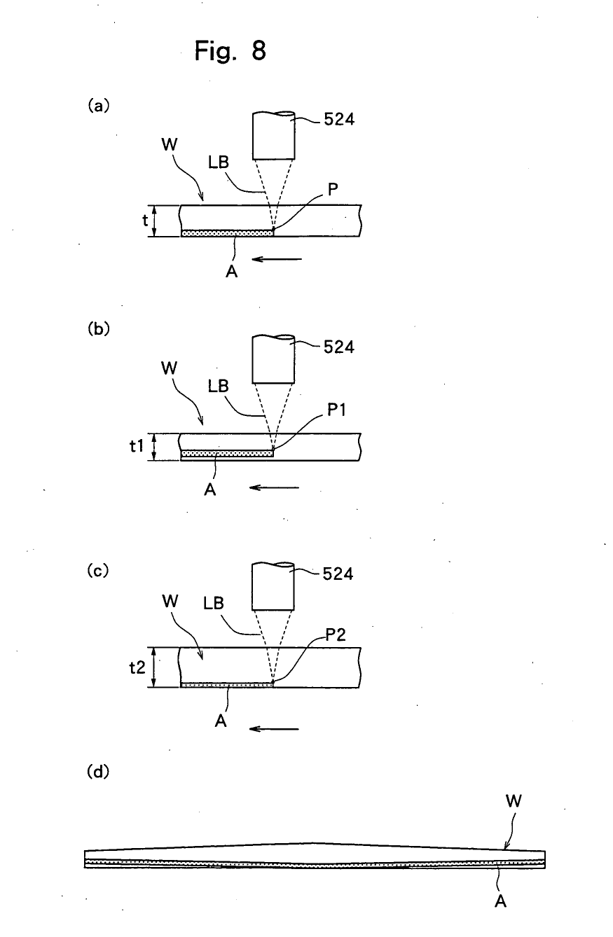

In this embodiment, as shown in FIG. 7(a) and FIG. 7(b), the present invention is applied to a circular plate-like workpiece (W) which is thick at the center and gradually thinner toward its periphery. That is, in this embodiment, the positions of heights of several points of the plate-like workpiece (W) are detected with the front surface of the chuck table as the reference position in a state of the plate-like workpiece being held on the chuck table, to obtain an undulation function f(x) based on the positions of heights of these several points, whereby the position of the focusing point of a laser beam is controlled.

The position (a) of the height of the top surface at the center of the plate-like workpiece (W) in FIG. 7(a) and FIG. 7(b), the position (b) of the height of the top surface at the left end of a dividing line in the first direction, which is a horizontal direction, in FIG. 7(b) passing through the center, the position (c) of the height of the top surface at the right end of the dividing line in the first direction, the position (d) of the height of the top surface at the upper end of a dividing line in a second direction, which is a vertical direction, in FIG. 7(b) passing through the center, and the position (e) of the height of the top surface at the lower end of the dividing line in the second direction are detected. When the radius of the plate-like workpiece (W) is represented by (r), the dividing line in the first direction passing through the center is represented by the X-axis coordinate, the dividing line in the second direction passing through the center is represented by the Y-axis coordinate, and the dividing lines in the first direction are all represented by local coordinates (rθ) with the X-axis coordinate as the standard, the undulation function f(x) of the dividing line in the first direction is represented by the following equations (1) and (2).

$$\begin{matrix}f ( x ) of first and fourth quadrants = \frac{[ \{ c + 2 ( d - c ) θ / π \} - \{ a + ( d - a ) sin θ \} ] \cdot X}{r \cdot cos θ} + \{ a + ( d - a ) sin θ \} & ( 1 ) \\ f ( x ) of second and third quadrants = \frac{[ \{ b + 2 ( d - b ) θ / π \} - \{ a + ( d - a ) sin θ \} ] \cdot X}{ r \cdot cos θ} + \{ a + ( d - a ) sin θ \} & ( 2 )\end{matrix}$$

When the dividing line in the first direction passing through the center is represented by the Y-axis coordinate, the dividing line in the second direction passing through the center is represented by the X-axis coordinate, and the diving lines in the second direction are all represented by local coordinates (re) with the X-axis coordinate as the standard, the undulation function f(x) of the dividing line in the second direction is represented by the following equations (3) and (4)

$$\begin{matrix}f ( x ) of first and fourth quadrants = \frac{[ \{ d + 2 ( b - d ) β / π \} - \{ a + ( d - a ) sin β \} ] \cdot X}{r \cdot cos β} + \{ a + ( b - a ) sin β \} & ( 3 ) \\ f ( x ) of second and third quadrants = \frac{[ \{ e + 2 ( b - e ) β / π \} - \{ a + ( d - a ) sin β \} ] \cdot X}{ r \cdot cos β} + \{ a + ( b - a ) sin β \} & ( 4 )\end{matrix}$$

After the undulation functions f(x) of the dividing lines in the first direction and the dividing lines in the second direction are obtained from the above equations (1), (2), (3) and (4), a correction value is obtained from the following equation.
correction value=(standard value−f(x))×refraction coefficient

The control means 10 obtains the position in the Z-axis direction of the condenser 524 from the following equation.
position in Z-axis direction=position of set height+correction value

The control means 10 controls the pulse motor 532 of the focusing point position control means 53 based on the thus obtained position in the Z-axis direction to position the condenser 524 at the position in the Z-axis direction.

In the above embodiments, the deteriorated layer is exposed to the surface on the chuck table side, that is, the surface on the side opposite to the side to which the laser beam is applied, of the plate-like workpiece. To form a deteriorated layer on the front surface side, to which the laser beam is applied, in conformity with the undulation of the plate-like workpiece, the condenser 524 of the laser beam application means 52 may be moved in the Z-axis direction in accordance with the current position of the plate-like workpiece without taking into consideration the refractive index of the plate-like workpiece.

1-4. (canceled)

5. A laser beam processing machine for applying a laser beam to a plate-like workpiece having dividing lines formed in a lattice pattern on the front surface thereof to form a deteriorated layer inside of the plate-like workpiece, along the dividing lines, said machine comprising
a chuck table for holding the plate-like workpiece;
a laser beam application means for applying a laser beam to capable of passing through the plate-like workpiece to the workpiece;
a processing-feed means for moving the chuck table and the laser beam application means relative to each other in a horizontal plane;
a focusing point control means for controlling the position of a focusing point of the laser beam applied by the laser beam application means;
a height detection means for detecting a height at a position on the surface of the plate-like workpiece, on a side thereof to which the laser beam is applied;
a storage means for storing height information detected by the height position detection means; and
a control means for controlling the focusing point position control means based on height information stored in the storage means, the control means obtaining a correction value based on a difference between a standard height and a height at a current position of the surface, and based on the refraction coefficient of the plate-like workpiece, the control means controlling the focusing point position control means based on the correction value.
